(19) United States
(12) Patent Application Publication
(10) Pub. No.: US 2021/0156697 A1
(43) Pub. Date: May 27, 2021

(54) METHOD AND DEVICE FOR IMAGE PROCESSING AND MOBILE APPARATUS

(71) Applicant: SZ DJI TECHNOLOGY CO., LTD., Shenzhen (CN)

(72) Inventors: Bo WU, Shenzhen (CN); Ang LIU, Shenzhen (CN); Litian ZHANG, Shenzhen (CN)

(21) Appl. No.: 17/166,977

(22) Filed: Feb. 3, 2021

Related U.S. Application Data
(63) Continuation of application No. PCT/CN2018/101745, filed on Aug. 22, 2018.

(51) Int. Cl. G01C 21/32; G05D 1/02; G06N 3/04; G06K 9/62; G06T 7/507

(52) U.S. Cl. CPC G01C 21/32; G05D 1/0246; G05D 1/0274; G05D 2201/0217; G06N 3/04; G06K 9/6218; G06T 7/507; G05D 1/0219

(57) ABSTRACT

An image processing method includes obtaining an environment image, processing the environment image to obtain an image of a tracked target, and excluding the image of the tracked target according to a map constructed by the environment image.

### CROSS-REFERENCE TO RELATED APPLICATION

This application is a continuation of International Application No. PCT/CN2018/101745, filed Aug. 22, 2018, the entire content of which is incorporated herein by reference.

### TECHNICAL FIELD

The present disclosure generally relates to the image processing technology field and, more particularly, to a method and a device for image processing, and a mobile apparatus.

### BACKGROUND

A robot needs to rely on a map to determine a region, in which the robot can move, during navigation. The map is constructed by using a depth image. During the construction of the map, a classification is not performed on objects. All data is used equally to construct the map. Therefore, in a tracking task, the map includes a tracked target and other environmental information. The robot needs to follow the tracked target, and meanwhile, avoid an obstacle. However, when the tracked target is relatively close to the robot, the tracked target is considered as an obstacle. Thus, a situation that a trajectory planned by the robot avoids the tracked target occurs.

### SUMMARY

Embodiments of the present disclosure provide an image processing method. The method includes obtaining an environment image, processing the environment image to obtain an image of a tracked target, and excluding the image of the tracked target according to a map constructed by the environment image.

Embodiments of the present disclosure provide an image processing device including a processor and a memory. The memory stores executable instructions that, when executed by the processor, cause the processor to obtain an environment image, process the environment image to obtain an image of a tracked target, and exclude the image of the tracked target according to a map constructed by the environment image.

Embodiments of the present disclosure provide a mobile apparatus including an image processing device. The image processing device includes a processor and a memory. The memory stores executable instructions that, when executed by the processor, cause the processor to obtain an environment image, process the environment image to obtain an image of a tracked target, and exclude the image of the tracked target according to a map constructed by the environment image.

### BRIEF DESCRIPTION OF THE DRAWINGS

FIG. 1 is a schematic flowchart of an image processing method according to some embodiments of the present disclosure.

FIG. 2 is another schematic flowchart of the image processing method according to some embodiments of the present disclosure.

FIG. 3 is another schematic flowchart of the image processing method according to some embodiments of the present disclosure.

FIG. 4 is a schematic diagram showing an image of a map without excluding a tracked target according to some embodiments of the present disclosure.

FIG. 5 is a schematic diagram showing an image of a map excluding the tracked target according to some embodiments of the present disclosure.

FIG. 6 is a schematic block diagram of an image processing device according to some embodiments of the present disclosure.

FIG. 7 is another schematic block diagram of the image processing device according to some embodiments of the present disclosure.

FIG. 8 is another schematic block diagram of the image processing device according to some embodiments of the present disclosure.

FIG. 9 is another schematic block diagram of the image processing device according to some embodiments of the present disclosure.

FIG. 10 is a schematic block diagram of a mobile apparatus according to some embodiments of the present disclosure.

### REFERENCE NUMERALS

| | | | |
|---|---|---|---|
| 100 | Image processing device | 10 | Image acquisition circuit |
| 20 | Processing circuit | 22 | Detection circuit |
| 24 | Cluster circuit | 30 | Exclusion circuit |
| 40 | Construction circuit | 50 | Fill circuit |
| 80 | Memory | 90 | Processor |
| 1000 | Mobile apparatus | TA | Target area |
| UA | Unknown area | | |

### DETAILED DESCRIPTION OF THE EMBODIMENTS

Embodiments of the present disclosure are described in detail below. Embodiments of the present disclosure are shown in the accompanying drawings. Same or similar signs represent same or similar elements or elements with same or similar functions. The description of embodiments with reference to the accompanying drawings are exemplary, which is merely used to explain the present disclosure and cannot be understood as a limitation of the present disclosure.

In the specification of the present disclosure, the terms “first” and “second” are merely used for descriptive purposes and may not be understood as indicating or implying relative importance or implicitly indicating a number of the indicated technical features. Therefore, a feature associated with “first” or “second” may explicitly or implicitly include one or more of such feature. In the specification of the present disclosure, “a plurality of” means two or more than two, unless otherwise specified.

In the specification of the present disclosure, unless otherwise specified, the terms “mounting,” “connection,” and “coupling” should be interpreted broadly, for example, they may include a fixed connection, a detachable connection, or an integral connection. The connection may further include a mechanical connection, electrical communication, or mutual communication. The connection may further include a connection through an intermediate medium, a communication inside two elements, or an interaction relationship of the two elements. Those of ordinary skill in the art may understand specific meanings of the terms in the present disclosure.

The following disclosure provides many different embodiments or examples for realizing different structures of the present disclosure. To simplify the present disclosure, components and settings of specific examples are described below. The components and settings are only examples and are not intended to limit the present disclosure. In addition, reference numbers and/or reference letters may be repeated in different examples of the present disclosure, and this repetition is for the purpose of simplification and clarity and does not indicate the relationship between embodiments and/or settings discussed. In addition, the present disclosure provides examples of various specific processes and materials, but those of ordinary skill in the art may be aware of an application of other processes and/or use of other materials.

Embodiments of the present disclosure are described in detail below. Examples of embodiments are shown in the accompanying drawings. Same or similar signs represent the same or similar elements or elements with the same or similar functions. The description of embodiments with reference to the accompanying drawings is exemplary, which is merely used to explain the present disclosure and cannot be understood as a limitation of the present disclosure.

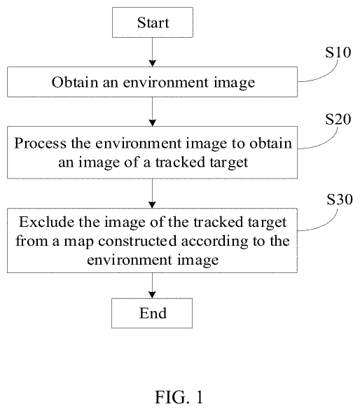

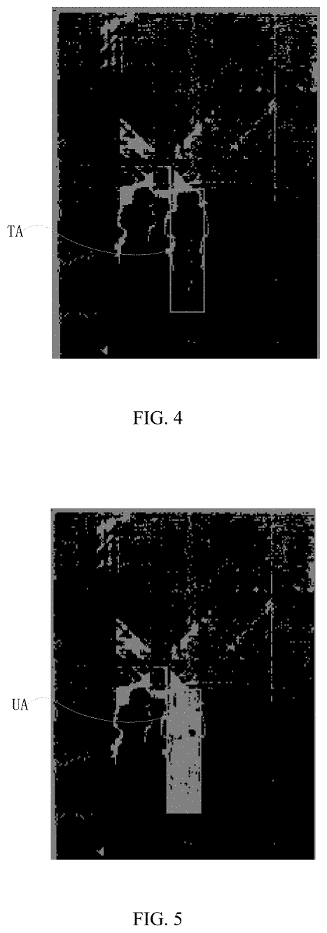

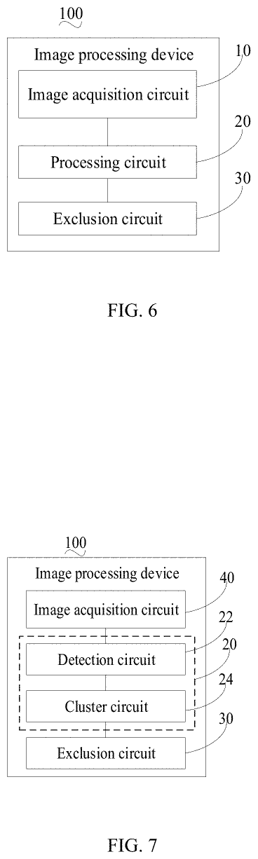

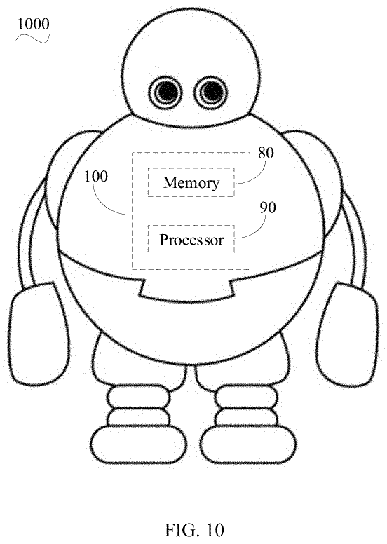

With reference to FIG. 1, FIG. 4, FIG. 6, and FIG. 10, an image processing method consistent with the present disclosure can be realized by an image processing device 100 consistent with the present disclosure, which can be applied to a mobile apparatus 1000 consistent with the present disclosure. The image processing method includes the following processes.

At S10, an environment image is obtained.

At S20, the environment image is processed to obtain an image of a tracked target. The image of the tracked target is also referred to as a “tracked-target image.”

At S30, the image of the tracked target is excluded from a map constructed according to the environment image.

According to the image processing method of embodiments of the present disclosure, the image of the tracked target can be excluded from the map such that the map does not include the tracked target. As such, the mobile apparatus 1000 may be prevented from avoiding the tracked target when tracking the tracked target.

During navigation, the mobile apparatus 1000 may need to rely on the map to obtain a region, in which the mobile apparatus 1000 may move. In a tracking task, the map may include the tracked target and other environmental information. The mobile apparatus 1000 may need to track the tracked target and meanwhile, avoid an obstacle. When the tracked target is relatively close to the mobile apparatus 1000, the mobile apparatus 1000 may consider the tracked target as an obstacle. As such, a path planned by the mobile apparatus 1000 may avoid the tracked target, which affects tracking. For example, when a trajectory of the tracked target includes a straight line, since the path planned by the mobile apparatus 1000 may avoid the tracked target, the trajectory of the mobile apparatus 1000 may not be consistent with the trajectory of the tracked target. The trajectory of the mobile apparatus 1000 may be changed to a curved line, which may not meet an expectation. Therefore, the image processing method of embodiments of the present disclosure may need to be performed to exclude the image of the tracked target from the map such that the map does not include the tracked target. As such, after the image of the tracked target is excluded from the map, even though the tracked target is relatively close to the mobile apparatus 1000, the mobile apparatus 1000 may not consider the tracked target as an obstacle. That is, the path planned by the mobile apparatus 1000 may not avoid the tracked target.

In the present disclosure, data of the mobile apparatus 1000 tracking the tracked target and data of the mobile apparatus 1000 avoiding the obstacle may be processed separately.

In some embodiments, process S10 includes using a first depth neural network algorithm to process an environment image to obtain the image of the tracked target.

After the environment image is obtained, the environment image may be transmitted into the first depth neural network (e.g., a convolutional neural network), and an image feature of the tracked target output by the first depth neural network may be obtained to obtain the image of the tracked target. That is, the image feature of the tracked target may be obtained by deep learning to obtain the image of the tracked target. In some embodiments, the environment image may be obtained and transmitted into the trained first depth neural network. The trained first depth neural network may be configured to perform recognition on an image of an object of a specific type. If the type of the tracked target is consistent with the specific type, the first depth neural network model may recognize the image feature of the tracked target of the environment image to obtain the image of the tracked target.

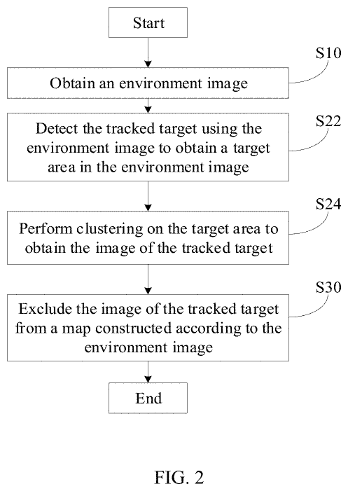

In some embodiments, as shown in FIG. 2, process S20 includes the following processes.

At S22, the tracked target is detected using the environment image to obtain a target area in the environment image.

At S24, clustering is performed on the target area to obtain the image of the tracked target.

In some embodiments, the environment image may include a depth image. The image processing method may include constructing the map according to the depth image. Process S22 may include using the depth image to detect the tracked target to obtain the target area TA in the depth image. The image processing method may include constructing the map according to the depth image.

The depth image may include depth data. Data of each pixel point of the depth image may include a real distance of a camera and an object. The depth image may represent three-dimensional scene information. Therefore, the depth image is usually used to construct the map.

The depth image may be obtained and photographed by a time of flight (TOF) camera, a binocular camera, or a structured light camera.

In some embodiments, the environment image may include a depth image and a color image. Process S22 may include using the color image to detect the tracked target to obtain the target area TA in the color image and obtaining the target area TA in the depth image according to a position correspondence of the depth image and the color image.

In some embodiments, the environment image may include the depth image and a gray scale image. Process S22 may include using the gray scale image to detect the tracked target to obtain the target area TA in the gray scale image and obtaining the target area TA in the depth image according to position correspondence of the depth image and the gray scale image.

The depth image, the color image, and the gray scale image may be obtained by the same camera arranged at a vehicle body of the mobile apparatus 1000. Therefore, coordinates of pixel points of the depth image, the color image, and the gray scale image may correspond to each other, that is, for each pixel point, a position of the pixel point of the depth image in the gray scale image or the color image may be the same as a position of the pixel point of the depth image in the depth image. In some other embodiments, the depth image, the color image, and the gray scale image may be obtained by different cameras arranged at the vehicle body of the mobile apparatus 1000. Thus, the coordinates of the pixel points of the depth image, the color image, and the gray scale image may not correspond to each other. The coordinates of the pixel points of the depth image, the color image, and the gray scale image may be obtained by mutual conversion of coordinate conversion relationship.

When the environment image includes the depth image, the tracked target may be detected in the depth image to obtain the target area TA. When the environment image includes the depth image and the color image, the tracked target may be detected in the color image to obtain the target area TA. The corresponding target area TA in the depth image may be obtained according to the correspondence relationship of the coordinates of the pixel points of the color image and the depth image. When the environment image includes the depth image and the gray scale image, the tracked target may be detected in the gray scale image to obtain the target area TA. The corresponding target area TA in the depth image may be obtained through the correspondence relationship of the coordinates of the pixel points of the gray scale image and the depth image. As such, the target area TA in the environment image may be obtained through a plurality of manners.

Further, process S22 may include using a second depth neural network algorithm to detect the tracked target in the environment image to obtain the target area TA in the environment image.

After the environment image is obtained, the environment image may be transmitted into the second depth neural network, and the target area TA output by the second neural network may be obtained. In some embodiments, the environment image may be obtained and transmitted into the trained second depth neural network. The trained second depth neural network may perform recognition on an object of a specific type. If the type of the tracked target is consistent with the specific type, the second depth neural network model may recognize the tracked target in the environment image and output the target area TA including the tracked target.

A corresponding application (APP) may be installed in the mobile apparatus 1000. In some other embodiments, after an initial environment image is obtained, a user may enclose and select the tracked target on a human-computer interface of the APP. As such, the target area TA may be obtained according to the feature of the tracked target of a last environment image. The human-computer interface may be displayed on a screen of the mobile apparatus 1000 or a screen of a remote apparatus (including but not limited to a remote controller, a cell phone, a laptop, a wearable smart device, etc.) that may communicate with the mobile apparatus 1000.

In some embodiments, the target area TA may include the image of the tracked target and the background of the environment image. Process S24 may include performing clustering on the target area TA to exclude the background of the environment image and obtaining the image of the tracked target.

Further, process S24 may include using a breadth-first search clustering algorithm to perform clustering on the target area TA to obtain the image of the tracked target. In some embodiments, the breadth-first search clustering algorithm may be used to obtain a plurality of connected areas in the target area TA and determine a largest connected area of the plurality of connected areas as the image of the tracked target.

Pixel points with similar chromaticity and similar pixel values may be connected to obtain a connected area. After the target area TA is obtained in the environment image, the breath-first search clustering algorithm may be used to perform connected area analysis on the target area TA, that is, the pixel points of the similar chromaticity and similar pixel values in the target area TA may be connected to obtain the plurality of connected areas. The largest connected area of the plurality of connected areas may include the image of the tracked image. As such, the image of the tracked target may be excluded from the target area TA, and the background of the environment image may be remained in the target area TA to prevent the environment information from losing.

In some other embodiments, clustering may be performed by using the pixel point at a center of the target area TA in the environment image (i.e., the depth image) as a start point. The clustering algorithm may determine the pixel points of the same type, that is, the clustering algorithm may differentiate the image of the tracked target from the background of the environment image in the target area TA to only obtain a depth image area that belongs to the tracked target. That is, the image of the tracked target may be obtained in the depth image.

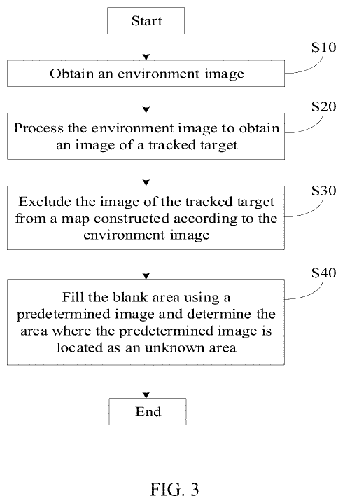

In some embodiments, after the image of the tracked target is excluded, the map may include a blank area corresponding to the position of the image of the tracked target. With reference to FIG. 3 and FIG. 5, the image processing method includes process S40, which includes filling the blank area using a predetermined image and determining the area where the predetermined image is located as an unknown area UA.

After the image of the tracked target is excluded from the map, the position of the image of the tracked target becomes the blank area. Thus, the predetermined image may be used to fill the blank area to cause the blank area to become the unknown area UA. Therefore, the mobile apparatus 1000 may not determine the tracked target as the obstacle, and the path planned by the mobile apparatus 1000 may not avoid the tracked target. The predetermined image may be composed of pixel points defined with invalid values. In some other embodiments, the blank area may be determined as the unknown area UA.

FIG. 4 shows the map without excluding the image of the tracked target. FIG. 5 shows the map with the image of the tracked target excluded. In FIG. 4, an area enclosed by a rectangle frame includes the target area TA. In FIG. 5, an area enclosed by a rectangle frame includes the unknown area UA.

FIG. 6 shows the image processing device 100 consistent with the present disclosure. The image processing device 100 includes an image acquisition circuit 10, a processing circuit 20, and an exclusion circuit 30. The image acquisition circuit 10 may be configured to obtain the environment image. The processing circuit 20 may be configured to process the environment image to obtain the image of the tracked target. The exclusion circuit 30 may be configured to exclude the image of the tracked target from the map constructed according to the environment image.

That is, process S10 of the image processing method of embodiments of the present disclosure may be implemented by the image acquisition circuit 10, process S20 may be implemented by the processing circuit 20, and process 30 may be implemented by the exclusion circuit 30.

The image processing device 100 of embodiments of the present disclosure may exclude the image of the tracked target from the map such that the map does not include the tracked target. As such, the mobile apparatus 1000 may be prevented from avoiding the tracked target during tracking the tracked target.

The description of embodiments and beneficial effects of the image processing method may be also suitable for the image processing device 100 of embodiments of the present disclosure, which is not detailed to avoid redundancy.

In some embodiments, the processing circuit 20 may be configured to use the first depth neural network algorithm to process the environment image to obtain the image of the tracked target.

In some embodiments, with reference to FIG. 7, the processing circuit 20 includes a detection circuit 22 and a cluster circuit 24. The detection circuit 22 may be configured to use the environment image to detect the tracked target to obtain the target area TA in the environment image. The cluster circuit 24 may be configured to perform clustering on the target area TA to obtain the image of the tracked target.

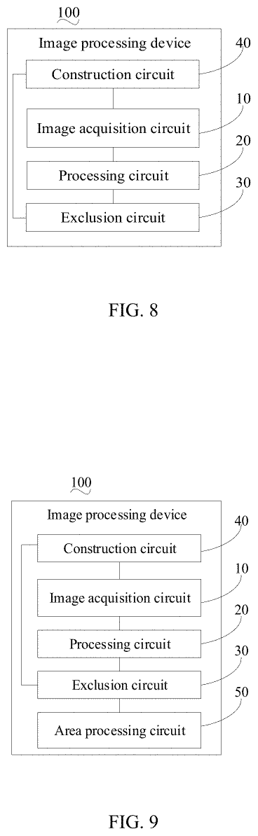

In some embodiments, the environment image may include the depth image. The detection circuit 22 may be configured to use the depth image to detect the tracked target to obtain the target area TA in the depth image. As shown in FIG. 8, the image processing device 100 further includes a construction circuit 40. The construction circuit 40 may be configured to construct the map according to the environment image.

In some embodiments, the environment image may include the depth image and the color image. The detection circuit 22 may be configured to use the color image to detect the tracked target to obtain the target area TA in the color image and obtain the target area TA in the depth image according to the position correspondence of the depth image and the color image. As shown in FIG. 8, the image processing device 100 further includes the construction circuit 40. The construction circuit 40 may be configured to construct the map according to the depth image.

In some embodiments, the environment image may include the depth image and a gray scale image. The detection circuit 22 may be configured to use the gray scale image to detect the tracked target to obtain the target area TA in the gray scale image and obtain the target area TA in the depth image according to the position correspondence of the depth image and the gray scale image. As shown in FIG. 8, the image processing device 100 further includes the construction circuit 40. The construction circuit 40 may be configured to construct the map according to the depth image.

In some embodiments, the image acquisition circuit 10 may include a TOF camera, a binocular camera, or a structured light camera. The depth image may be obtained and photographed by the TOF camera, the binocular camera, or the structured light camera.

In some embodiments, the detection circuit 22 may be configured to use the second depth neural network algorithm to detect the tracked target in the environment image to obtain the target area TA in the environment image.

In some embodiments, the target area TA may include the image of the tracked target and the background of the environment image. The cluster circuit 24 may be configured to perform clustering on the target area TA to exclude the background of the environment image and obtain the image of the tracked target.

In some embodiments, the cluster circuit 24 may be configured to use the breadth-first search clustering algorithm to perform the clustering on the target area TA to obtain the image of the tracked target.

In some embodiments, the cluster circuit 24 may be configured to use the breadth-first search clustering algorithm to obtain the plurality of connected areas in the target area TA and determine the largest connected area of the plurality of connected areas as the image of the tracked target.

In some embodiments, after the image of the tracked target is excluded, the map may include the blank area corresponding to the position of the image of the tracked target. With reference to FIG. 9, the image processing device 100 includes an area processing circuit 50. The area processing circuit 50 may be configured to use the predetermined image to fill the blank area and determine the area where the predetermined image is located as the unknown area UA or determine the blank area directly as the unknown area UA.

FIG. 10 shows another example of the image processing device 100 applied to the mobile apparatus 1000. The image processing device 100 shown in FIG. 10 includes a memory 80 and a processor 90. The memory 80 may store executable instructions. The processor 90 may be configured to execute the instructions to implement an image processing method consistent with the present disclosure, such as one of the above-described example image processing methods.

The image processing device 100 of embodiments of the present disclosure may exclude the image of the tracked target from the map such that the map does not include the tracked target. As such, the mobile apparatus 1000 may be prevented from avoiding the tracked target while tracking the tracked target.

The mobile apparatus 1000 of embodiments of the present disclosure can include any one of the above example image processing device 100.

The mobile apparatus 1000 of embodiments of the present disclosure may exclude the image of the tracked target from the map such that the map does not include the tracked target. As such, the mobile apparatus 1000 may be prevented from avoiding the tracked target while tracking the tracked target.

The image processing device 100 shown in the drawings includes the memory 80 (e.g., a non-volatile storage medium) and the processor 90. The memory 80 may be configured to store the executable instructions. The processor 90 may be configured to execute the instructions to perform an image processing method consistent with the present disclosure, such as one of the above-described example image processing method. The mobile apparatus 1000 may include a mobile vehicle, a mobile robot, an unmanned aerial vehicle, etc. The mobile apparatus 1000 shown in FIG. 10 includes a mobile robot.

The above description of embodiments and beneficial effects of the image processing method and the image processing device 100 are also applicable to the mobile apparatus 1000 of embodiments of the present disclosure, which are not described in detail to avoid redundancy.

In the description of this specification, the description of the terms “one embodiment,” “some embodiments,” “exemplary embodiments,” “examples,” “specific examples,” or “some examples” is intended to include the specific features, structures, materials, or characteristics described in connection with the embodiments or examples in at least one embodiment or example of the present disclosure. In this specification, the schematic representations of the above terms do not necessarily refer to same embodiments or examples. Moreover, the described specific features, structures, materials, or characteristics can be combined in an appropriate manner in any one or more embodiments or examples.

Any process or method description described in the flowchart or described in other manners herein may be understood as a module, a segment, or a part of codes that include one or more executable instructions used to execute specific logical functions or steps of the process. The scope of some embodiments of the present disclosure may include additional executions, which may not be in the order shown or discussed, including executing functions in a substantially simultaneous manner or in a reverse order according to the functions involved. Those skilled in the art to which embodiments of the present disclosure belong should understand such executions.

The logic and/or steps represented in the flowchart or described in other manners herein, for example, may be considered as a sequenced list of executable instructions for executing logic functions, and may be executed in any computer-readable medium, for instruction execution systems, devices, or apparatuses (e.g., computer-based systems, including systems of processors, or other systems that can fetch instructions from instruction execution systems, devices, or, apparatuses and execute the instructions) to use, or used in connection with these instruction execution systems, devices, or apparatuses. For this specification, a “computer-readable medium” may include any device that can contain, store, communicate, propagate, or transmit a program for use by the instruction execution systems, devices, or apparatuses, or in combination with these instruction execution systems, devices, or apparatuses. More specific examples (e.g., non-exhaustive list) of the computer-readable medium include an electrical connection (e.g., electronic device) with one or more wiring, a portable computer disk case (e.g., magnetic device), a random access memory (RAM), a read-only memory (ROM), an erasable and editable read-only memory (EPROM or flash memory), a fiber optic device, and a portable compact disk read-only memory (CDROM). In addition, the computer-readable medium may even be paper or other suitable media on which the program may be printed, because, for example, the program may be obtained digitally by optically scanning the paper or other media, and then editing, interpreting, or processing by other suitable manners when necessary. Then, the program may be saved in the computer storage device.

Each part of the present disclosure may be implemented by hardware, software, firmware, or a combination thereof. In embodiments of the present disclosure, multiple steps or methods may be executed by software or firmware stored in a memory and executed by a suitable instruction execution system. For example, when the steps or methods are executed by the hardware, the hardware may include a discrete logic circuit of a logic gate circuit for performing logic functions on data signals, an application-specific integrated circuit with a suitable combinational logic gate circuit, a programmable gate array (PGA), a field-programmable gate array (FPGA), etc.

Those of ordinary skill in the art can understand that all or part of the steps carried in the above implementation method may be completed by a program instructing relevant hardware. The program may be stored in a computer-readable storage medium. When the program is executed, one of the steps of method embodiments or a combination thereof may be realized.

In addition, each functional unit in embodiments of the present disclosure may be integrated into one processing module, or each unit may exist individually and physically, or two or more units may be integrated into one module. The above-mentioned integrated modules may be executed in the form of hardware or software functional modules. If the integrated module is executed in the form of a software functional module and sold or used as an independent product, the integrated module may also be stored in a computer-readable storage medium.

The storage medium may be a read-only memory, a magnetic disk, or an optical disk, etc. Although embodiments of the present disclosure have been shown and described above, the above embodiments are exemplary and should not be considered as limitations of the present disclosure. Those of ordinary skill in the art may perform modifications, changes, replacements, or variations on embodiments of the present disclosure within the scope of the present disclosure.

What is claimed is:

1. An image processing method comprising:
obtaining an environment image;
processing the environment image to obtain an image of a tracked target; and
excluding the image of the tracked target from a map constructed according to the environment image.

2. The method of claim 1, wherein processing the environment image to obtain the image of the tracked target includes:
processing the environment image using a depth neural network algorithm to obtain the image of the tracked target.

3. The method of claim 1, wherein processing the environment image to obtain the image of the tracked target includes:
detecting the tracked target using the environment image to obtain a target area in the environment image; and
performing clustering on the target area to obtain the image of the tracked target.

4. The method of claim 3,
wherein:
the environment image includes a depth image; and
detecting the tracked target using the environment image to obtain the target area in the environment image includes detecting the tracked target using the depth image to obtain the target area in the depth image;
the method further comprising:
constructing the map according to the depth image.

5. The method of claim 3,
wherein:
the environment image includes a depth image and a color image; and
detecting the tracked target using the environment image to obtain the target area in the environment image includes:
detecting the tracked target using the color image to obtain the target area in the color image; and
obtaining the target area in the depth image according to a position correspondence of the depth image and the color image;
the method further comprising:
constructing the map according to the depth image.

6. The method of claim 3,
wherein:
the environment image includes a depth image and a gray scale image; and
detecting the tracked target using the environment image to obtain the target area in the environment image includes:
detecting the tracked target using the gray scale image to obtain the target area in the gray scale image; and
obtaining the target area in the depth image according to a position correspondence of the depth image and the gray scale image;
the method further comprising:
constructing the map according to the depth image.

7. The method of claim 3, wherein detecting the tracked target using the environment image to obtain the target area in the environment image includes:
detecting the tracked target using a depth neural network algorithm in the environment image to obtain the target area in the environment image.

8. The method of claim 3, wherein:
the target area includes the image of the tracked target and background of the environment image; and
performing clustering on the target area to obtain the image of the tracked target includes:
performing the clustering on the target area to exclude the background of the environment image to obtain the image of the tracked target.

9. The method of claim 3, wherein performing clustering on the target area to obtain the image of the tracked target includes:
performing the clustering on the target area using a breadth-first search clustering algorithm to obtain the image of the tracked target.

10. The method of claim 1, further comprising:
determining a blank area in the map as an unknown area, the blank area corresponding to a position of the image of the tracked target after the image of the tracked target is excluded; or
filling the blank area using a predetermined image and determining an area where the predetermined image is located as the unknown area.

11. An image processing device comprising:
a processor; and
a memory storing executable instructions that, when executed by the processor, cause the processor to:
obtain an environment image;
process the environment image to obtain an image of a tracked target; and
exclude the image of the tracked target from a map constructed according to the environment image.

12. The device of claim 11, wherein the instructions further cause the processor to:
process the environment image using a depth neural network algorithm to obtain the image of the tracked target.

13. The device of claim 11, wherein the instructions further cause the processor to:
detect the tracked target using the environment image to obtain a target area in the environment image; and
perform clustering on the target area to obtain the image of the tracked target.

14. The device of claim 13, wherein:
the environment image includes a depth image; and
the instructions further cause the processor to:
detect the tracked target using the depth image to obtain the target area in the depth image; and
construct the map according to the depth image.

15. The device of claim 13, wherein:
the environment image includes a depth image and a color image; and
the instructions further cause the processor to:
detect the tracked target using the color image to obtain the target area in the color image;
obtain the target area in the depth image according to a position correspondence of the depth image and the color image; and
construct the map according to the depth image.

16. The device of claim 13, wherein:
the environment image includes a depth image and a gray scale image; and
the instructions further cause the processor to:
detect the tracked target using the gray scale image to obtain the target area in the gray scale image;
obtain the target area in the depth image according to a position correspondence of the depth image and the gray scale image; and
construct the map according to the depth image.

17. The device of claim 13, wherein the instructions further cause the processor to:
detect the tracked target in the environment image using a depth neural network algorithm to obtain the target area in the environment image.

18. The device of claim 13, wherein:
the target area includes the image of the tracked target and background of the environment image; and
the instructions further cause the processor to:
perform the clustering on the target area to exclude the background of the environment image to obtain the image of the tracked target.

19. The device of claim 13, wherein the instructions further cause the processor to:
perform the clustering on the target area using a breadth-first search clustering algorithm to obtain the image of the tracked target.

20. A mobile apparatus comprising an image processing device including:
a processor; and
a memory storing executable instructions that, when executed by the processor, cause the processor to:
obtain an environment image;
process the environment image to obtain an image of a tracked target; and
exclude the image of the tracked target from a map constructed according to the environment image.
